(19) United States
(12) Patent Application Publication
(10) Pub. No.: US 2024/0178927 A1
(43) Pub. Date: May 30, 2024

(54) BROADCAST RADIO RECEIVING METHOD

(71) Applicant: PANASONIC INTELLECTUAL PROPERTY MANAGEMENT CO., LTD., Osaka (JP)

(72) Inventor: Andreas DICKS, Heidgraben (DE)

(21) Appl. No.: 18/522,630

(22) Filed: Nov. 29, 2023

(30) Foreign Application Priority Data
Nov. 30, 2022 (DE) 102022131688.2

(51) Int. Cl. H04H 20/28; H04H 20/10

(52) U.S. Cl. CPC H04H 20/28; H04H 20/106

(57) ABSTRACT

The present invention relates to a broadcast radio receiving method addressing the desire for allowing a rapid switching between different services as selected by a user. In order to provide an approach for reducing or even avoiding delays involved with service switching tailored to the context of radio broadcast reception, in particular in view of limited tuner resources, and/or in order to provide an approach for addressing a selection of a new service in case of, for example, signal loss, the prediction focuses on the user's sequential selection behavior.

### CROSS-REFERENCE TO RELATED APPLICATIONS

This application is based on and claims priority under 35 USC 119 from German Patent Application No. 102022131688.2 filed on Nov. 30, 2022, the contents of which are incorporated herein by reference.

### TECHNICAL FIELD

The present invention relates to a broadcast radio receiver and a broadcast radio receiving method addressing the desire for allowing a rapid switching between different services as selected by a user and/or addressing the desire for a convenient approach in case of reception loss.

### BACKGROUND ART

Broadcast radio systems always require a certain time to tune in to a different station. This applies to all kinds of broadcast radio standards, but especially digital radio standards are affected because of their complex processing for digital demodulation (e.g. OFDM) and audio decoding (e.g. HE-AAC). When changing the station, it takes some time to gather enough information before the receiver is able to decode the corresponding audio stream.

Digital broadcast standards like DAB (Digital Audio Broadcasting) or DRM (Digital Radio Mondiale) allow frequency channels to carry a multitude of audio or data services. Particularly when selecting a station on a different frequency, it takes more time because the tuner has to tune in to the new frequency and the service information for the whole channel has to be collected subsequently. This time might extend even more when dealing with weak-signal conditions, as parts of the service information might be missed and recollected later. A DAB system requires typically 1 to 1.5 seconds to retune, whereas in case of a weak signal this might take up to 5 seconds. With DRM it is even worse, a typical tune operation takes 4 seconds before audio is available, even with good reception. This can extend to 30 seconds and more in case of bad reception.

From an end user's point of view this is inconvenient or may even be unacceptable.

A known approach in receiving systems makes use of the provision of multiple tuners in a multi-tuner system. In such multi-tuner systems usually one tuner is used to listen to the currently selected station and the remaining tuner(s) serve(s) to keep the station list up-to-date, to monitor data services and/or to prepare service linking. These extra tuners have not been used yet for station (or service) selection with reduced tuning time.

FIG. 1 shows a schematic representation for illustrating a conventional broadcast radio receiver system 10 having two tuners. The user 1 operates a Human Machine Interface 2 (HMI) (for example, a Graphical User Interface (GUI)) to select a radio station. The interface 2 sends the registered user interaction to a controller 3, which transforms it into a sequence of commands dispatched to the analog (e.g. AM/FM) or digital (e.g. DAB/DRM) tuners 5, 6 for proper station selection. The tuners 5, 6 receive an RF signal from an aerial 4, demodulate it to a baseband signal and, in case of digital radio, decode it, resulting in separate audio data streams. A selector 7 picks one of these audio streams, converts it to an analog audio signal and sends it to a loudspeaker 8 for reproduction. In this scenario no station prediction is conducted and tuning times are determined by the radio standard and the current reception conditions.

With multiple tuners, one may improve tuning times by using one or several of those remaining tuners to prepare for the selection of the next station.

FIG. 2 shows a schematic representation for illustrating a broadcast radio receiver system 20 employing prediction but not having the ability to learn. The broadcast radio receiver system 20 of FIG. 2 largely corresponds to that of FIG. 1, wherein, in addition, a predictor 9 is provided. The predictor 9 receives information as to which station is currently selected, i.e. which station the user 1 is listening to. The predictor 9 uses this piece of information and a simple internal model to predict the next station to be prepared and selected. This model might be based on a simple assumption, for example that the user tends to go through the list of station presets or through the list of available stations from top to bottom. Another use case is the seek function of a radio. When pressing the seek-up button the system selects the next station in a physical or logical order (e.g. frequency order), pressing the seek-down button gives access to the previous station. Especially in this case it is easy to predict the station to select next as long as the user does not change the seek direction. Without any dynamic adjustment, however, the prediction will fail, once the user changes his behavior.

Since there are many different stations and only a limited number of available tuners, in order to be effective in avoiding tuning delays under more complicated user behaviours, a more sophisticated prediction is needed of which station is to be selected next. If such prediction is successful, i.e. the user actually selects the predicted station which the auxiliary tuner has already selected, the radio system does not need to tune in again, it just changes to the corresponding audio source, thus saving time.

The predictor, i.e. the unit providing the prediction, is thus preferably able to learn and to adjust itself to the end user's behavior, in order to increase the likelihood of success. The methods of Reinforcement Learning, a special field of Machine Learning, provide a suitable way of implementing such a self-learning predictor, since with each selection of a new station there is feedback on whether the prediction has been good or bad. This feedback can be immediately used to adjust the predictor.

In a not directly related technical area, an example of pre-fetching of information in order to facilitate channel or service switching is proposed in US 2021/0099752 A1, which aims at preparing access to data sources for quicker availability. US 2021/0099752 A1 generally describes an internet video streaming management for video-on-demand and live content. The user's service preferences are predicted and data from services that the user presumably most likely selects is pre-fetched.

In addition to the above, there might also be cases where there might be a desire for an extension of service linking as known from DAB. If the reception of a service is lost, unless the user prefers to stop listening to the radio, another service needs to be selected.

### SUMMARY OF INVENTION

An aim underlying the present invention is to provide an approach for reducing or even avoiding delays involved with service switching tailored to the context of radio broadcast reception, in particular in view of limited tuner resources. Another aim underlying the present invention is to provide for an approach which allows for a convenient selection of a new service in case the current service is lost and no conventionally known service linking or the like is available.

Thus, there is a desire to have a broadcast radio receiver which makes use of an additional (auxiliary) tuner (in addition to the (main) tuner currently providing the audio data for reproduction), wherein the additional tuner is tuned to a service which is predicted as being selected next by the user. In case of the aspect addressing the lost reception, this might even apply to cases where no further tuner is provided.

According to a first aspect of the invention, a broadcast radio receiving method is proposed, in particular a broadcast radio receiving method includes the steps of receiving an input from a user, as to a selection of a radio service; controlling, in response to the selection of the radio service by the user, one of a first and a second tuner, so to obtain service signals from the selected radio service and to provide audio data for reproduction, in which the first and the second tuner are each configured to obtain, independently from each other, service signals from a radio service and to provide audio data for reproduction; predicting a next radio service based on the selected radio service, in which the prediction is based on information as to previous sequential selections; controlling the other one of the first and second tuner to obtain the service signals from the next radio service predicted by the predicting step; and receiving a further input from the user, as to a subsequent selection of a radio service. If the subsequent selection corresponds to the prediction, the method further includes stopping the provision of audio data for reproduction by the one of the first and the second tuner and controlling the other one of the first and second tuner to provide the audio data of predicted radio service for reproduction, and if the subsequent selection does not correspond to the prediction, the method further includes controlling either the first or second tuner, so to obtain the service signals from the radio service indicated by the subsequent selection and to provide the audio data for reproduction. Further, the method includes, in response to the subsequent selection of the radio service, updating the information as to previous sequential selections.

According to a second aspect of the invention, a broadcast radio receiving method is proposed, in particular a broadcast radio receiving method includes the steps of obtaining service signals from a radio service; providing audio data for reproduction; receiving an input from a user, as to a selection of a radio service; and predicting a next radio service based on the selected radio service, wherein the prediction is based on information as to previous sequential selections. Further, the method includes, in case of a signal loss for the selected radio service, indicating the predicted next radio service to the user or changing the obtaining of service signals to the predicted next radio service. The method further includes, in response to a subsequent selection of the radio service by the user via the interface, updating the information as to previous sequential selections.

The predictor may be provided in different ways. In one embodiment, the predictor (and in this regard also the broadcast radio receiver) may be provided in a self-contained way, in the sense that the predictor itself is configured to carry out the prediction just by itself. In another embodiment, the predictor may include a communication interface allowing communication with a server or the like (e.g. a cloud service), wherein the predictor is configured to forward information to the server and to receive prediction data in response. Such communication interface may make use of communication equipment provided, for example, in a vehicle in which the broadcast radio receiver is provided. In a further embodiment, the predictor may include a short range communication interface (or may connect with a corresponding interface of the vehicle), allowing for communication with a smart phone (or similar device) of the user, wherein, in particular, the computational aspects of the prediction may be carried out by the smart phone. These embodiments may be combined, e.g. the predictor may be configured to carry out a prediction in line with computational constraints if no connection is possible and may connect with the server and/or with the smart phone (or the like) when available, so that more demanding computational tasks may be carried out by the server and/or the smart phone. An interfacing with a smart phone may allow, in addition and as an alternative to an interface of the broadcast radio receiver itself, the user to change setting of the predictor.

In an advantageous embodiment of an aspect of the invention, the predictor is configured to update the information as to previous sequential selections by means of reinforcement learning. The updating by means of reinforcement learning allows to modify future prediction, wherein a correct prediction confirms (and reinforces) the configuration or setting leading to such prediction and an incorrect prediction leads to a negative modification, which may allow an improvement in further predictions.

In a further advantageous embodiment of an aspect of the invention, the information as to previous sequential selections is provided in form of a table, indicating, for each of a set of services, a likelihood for a subsequent selection of another one of the set of services, or includes such table. The provision of the information, on which the prediction is based, in form of a table allows for a comparatively simply structure of the predictor, in particular in comparison to computational resources otherwise needed by machine learning.

In a further advantageous embodiment of an aspect of the invention, the information as to previous sequential selections is provided by means of a learned model, in particular based on neural network, indicating, for each of a set of services, a likelihood for a subsequent selection of another one of the set of services, or includes such learned model. While the provision of machine learning may bring about a need for more computational resources in comparison to the above mentioned table approach, depending on the number of factors considered in the prediction, the size of the table may increase to such a point that the simpler computational results from a table may be offset by the necessary data size of the table. In other words, a higher number of factors may mean that a learned model may be less demanding than an excessively large table.

In a further advantageous embodiment of an aspect of the invention, the predictor is configured to predict the next radio service based on the selected radio service and a predetermined number of previously selected radio services. Rather than basing the prediction only on the currently selected radio service, the prediction may use as input the previous sequence of selected radio services, allowing a better distinction between cases where, for example, the user may select services A, B and C and services D, B and E in sequence, respectively. Assuming that the currently selected service is B, the consideration of the previous sequence (here taking into account of the previous selection of A or of D), would allow to predict whether the user is more likely to select C or E next.

In a further advantageous embodiment of an aspect of the invention, the broadcast radio receiving method further includes obtaining, by a locator, current location data of the broadcast radio receiver. The predicting step includes predicting the next radio service based on the selected radio service and based on the current location data. The prediction may take into consideration the physical location of the broadcast radio receiver (i.e. the user), which may have an influence of the next selection of a service.

In a further advantageous embodiment of an aspect of the invention, the broadcast radio receiving method further includes indicating a current time by a timer. The predicting step includes predicting the next radio service based on the selected radio service and based on the current time. Similar to the above, in addition or alternatively to the location, also the time of day (e.g. the more or less exact time or more generally a time of day like morning, noon, afternoon, evening and night) may influence the user in selecting the next service, so it is advantageous to take into consideration such information for the prediction.

In a preferred variation of the above embodiment making use of the current location for the prediction (which may be combined with the above aspect of using the time, as well), the predicting step includes predicting the next radio service based on the selected radio service, based on the current location data and based on location data previous to the current location data. When the predictor maintains a list of previously taken routes (i.e. considers the change of the location over time; possibly limited to a predetermined number of routes taken most regularly) in connection with the respectively selected services, this might further improve the prediction results, since there is a good chance that, at least for the regularly taken routes (in particular at similar times), the user may follow a habit reflected in a predictable sequence. The locator may be configured to store information about a number of (previously taken) routes, wherein respective route IDs are assigned to such routes. The locator may further be configured to compare a current route to the stored routes and as long as the current route matches one of these, the respective ID may be provided to the predictor as input for the prediction. If it is found, by the locator, based on the current route and the stored routes, that there is a deviation (i.e. a new route), a different (new) ID may be provided or a previously assigned ID may be reassigned. Known approaches, with which the skilled person is familiar, may be used for managing the information on the routes, in particular with the aim of ensuring that the most frequently (or regularly) used routes are considered, wherein there might be a change over time in such regard. Similarly, a threshold may be provided for allowing minor deviations (e.g. in case of a road detour) between routes before such routes would be identified as being distinct.

In a further advantageous embodiment of an aspect of the invention, the controlling step includes releasing the other one of the first and second tuner from obtaining the service signals from the next radio service predicted by the predictor after a predetermined interval from the selection of the radio service from the user. It is foreseen that the time window, within which a predicted station selection is (made) available is limited, in order to allow for a more efficient resource usage. For example, in a dual-tuner system, the alternative tuner might be used for predicted station selection up to 10 seconds after the user has initially selected a station. When this time expires, it is assumed that the user will not change the station anymore and the alternative tuner can be used for other purposes like station list update or service following. The above mentioned time limit may be adjusted based on a user behavior, in the sense that it may be detected if the user tends to take more (or less) time for switching to a different service after the previous selection, wherein this time limit may even be individually set (and adjusted) for each service.

In a further advantageous embodiment of an aspect of the invention, the controlling step include, in response to a predetermined condition, releasing the other one of the first and second tuner from obtaining the service signals from the next radio service predicted by the predictor, wherein the controller is further configured, after such release, to again control the other one of the first and second tuner to obtain the service signals from the next radio service predicted by the predictor in response to a predetermined trigger condition, in particular in case of a detected stop of a vehicle in which the broadcast radio receiver is provided and/or in case of a deterioration of a reception quality of the selected radio service below a predetermined threshold. If, for example, as mentioned above, after a certain time limited, the tuner obtaining the predicted service data is released and used for other purposes, it can be provided that in predefined cases the prediction is “re-instated” and the additional tuner again obtains the predicted service data. Opportunities to actively pursue tuning prediction may be cases where the vehicle stops (e.g. at the traffic lights when the user can easily pay attention to the broadcast radio) or when the current reception quality fades and no (DAB) alternative for service linking is available.

In a further advantageous embodiment of an aspect of the invention, an audio system is provided, including a broadcast radio receiver according to the present invention and a loudspeaker configured to reproduce audio data provided for reproduction by the first or the second tuner.

In a preferred variation of the above embodiment, a vehicle is provided including the audio system.

According to a further aspect of the invention, a non-volatile memory device is proposed with computer program that causes a computer to carry out the steps of the method according to the invention. The computer program may be provided, stored and/or distributed on a suitable medium, such as an optical storage medium or a non-volatile solid-state medium. The computer program may be supplied together with or as part of other hardware, but may also be distributed in other forms, such as via the Internet or other wired or wireless telecommunication systems.

Features of preferred embodiments of the invention are defined, in particular, in the dependent claims, while further advantageous features, embodiments and implementations are apparent to the skilled person from the above explanation and the following discussion.

### BRIEF DESCRIPTION OF DRAWINGS

In the following, the present invention is further elucidated and exemplified under reference to embodiments illustrated in the attached drawings, in which

FIG. 1 shows a schematic representation for illustrating a conventional broadcast radio receiver system;

FIG. 2 shows a schematic representation for illustrating a broadcast radio receiver system employing prediction but not having the ability to learn;

FIG. 3 shows a schematic representation for illustrating a first exemplary embodiment of the broadcast radio receiver according to the invention;

FIG. 4 shows a schematic flow diagram of an exemplary embodiment of a broadcast receiving method according to the invention, and

FIG. 5 shows a schematic representation for illustrating a second exemplary embodiment of the broadcast radio receiver according to the invention.

### DESCRIPTION OF EMBODIMENTS

In the attached drawings and the explanations on these drawings elements, which are in relation or in correspondence, are indicated—where expedient—by corresponding or similar reference signs, regardless of whether or not the elements are part of the same embodiment.

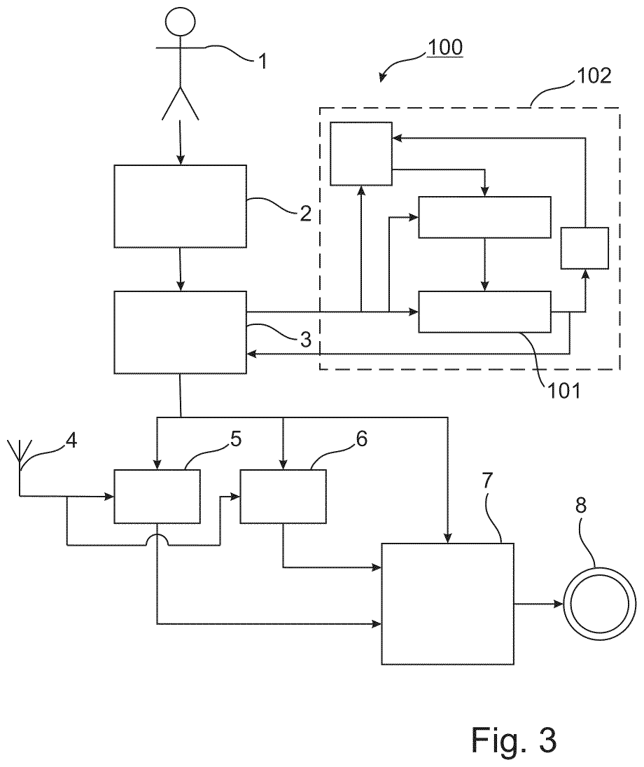

FIG. 3 shows a schematic representation for illustrating a first exemplary embodiment of the broadcast radio receiver according to the invention.

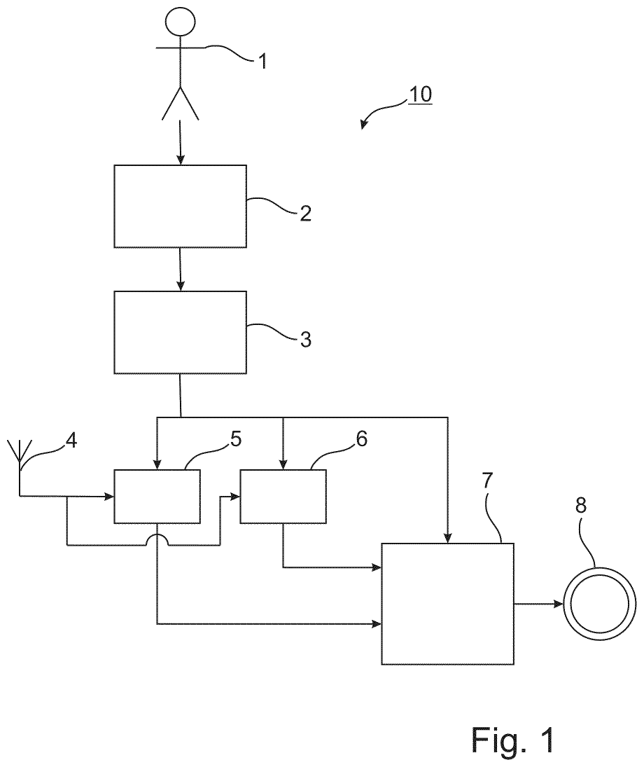

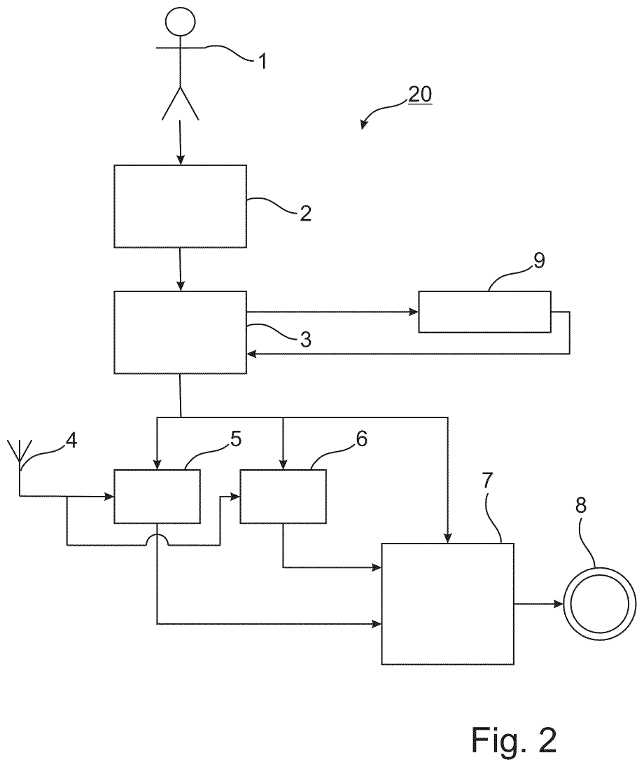

As with FIGS. 1 and 2, some basic components of an audio system 100 as shown in FIG. 3 include the interface 2 for receiving input from a user 1, a controller 3, tuners 5, 6 which are controlled by the controller 3, receive input from an antenna or aerial 4 and are connected to a selector 7 (under the control of the controller 3), which forwards the current audio stream to a speaker for reproduction.

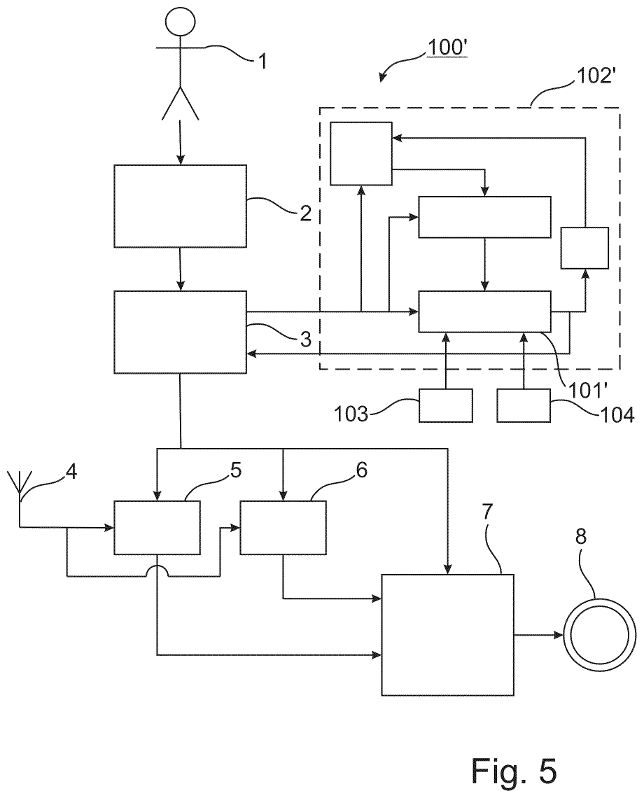

The audio system 100 includes a predictor 101 connected to the controller 3, receiving information as to a currently selected service and providing a prediction as to a service likely to be selected next by the user 1. In modifications of the present embodiment, the predictor may be provided with information on the current location (see also below, in regard to FIG. 5), the current time (see also below in regard to FIG. 5), a currently travelled route (e.g. in form of an ID identifying a route from a set of previously taken routes), and/or other information which might be useful for the prediction.

The predictor 101 is provided with a learning framework 102, which makes use of information as to service selected next by the user 1 for updating the basis for the prediction. Thus, FIG. 3 illustrates a self-learning prediction concept using the information on success or failure of the prediction as a learning reward.

It takes the currently selected station and the previously predicted station, checks if they match and feeds this result back into the predictor. The predictor 101 uses this feedback value to adjust its predictions such that the likelihood of successful predictions increases, i.e. provides Reinforcement Learning. As additional information the currently selected station is used as well to update the predictor 101.

Many different approaches to Reinforcement Learning exist, e.g. table-based approaches referring to Finite Markov Decision Processes or even Deep Learning methods based on Neural Networks.

The actual implementation of the self-learning predictor is not an essential part of this invention disclosure. A simple example of a table-based approach is given here as an example.

In order to model the transition from one selected radio station to the next station, in this example, a square table is used, which contains as many rows and as many columns as there are radio stations involved in the prediction process. Once the user selects a new radio station that has not been selected before, the station is added to the table by extending it by one row and one column. The rows stand for all radio stations that might be the origin of a change to a new station, the columns refer to all radio stations the user might select the next time, i.e. the destination of a station change. The table values (which are arbitrarily provided in this example) indicate the likelihood of success and determine the prediction of the next station by following these steps.
1. Go to the table row associated with the currently selected station (e.g. second line)
2. Look for the maximum value within this row (third row)
3. The column of the maximum value indicates the best prediction of the next station
4. If there is no single maximum value, choose one randomly among the highest values

to

| from | Station A | Station B | Station C | Station D |
|---|---|---|---|---|
| Station A | — | 42 | 12 | 15 |
| Station B | 5 | — | 55 | 20 |
| Station C | 11 | 8 | — | 48 |
| Station D | 52 | 4 | 7 | — |

By adjusting the table values after each station selection the predictor 101 is able to learn. This update discerns whether the prediction was successful or not. If it was successful, the previously found maximum value is increased taking a positive reward into account. If the prediction was wrong, the previously found maximum value is decreased taking a reward of 0 into account and additionally the table entry of the actually selected station is increased. The expression used for these updates is given in the equation below, which is a simplified version derived from the well-known Q-learning algorithm.

q_{updated}=q_{original}+α·(R−q_{original})
q_{original}: Table value to be updated
q_{updated}: Updated table value
α: Learn rate (0<α<1, e.g. 0.1)
R: Reward
   (e.g. 100 for an increase,
   0 for a decrease)

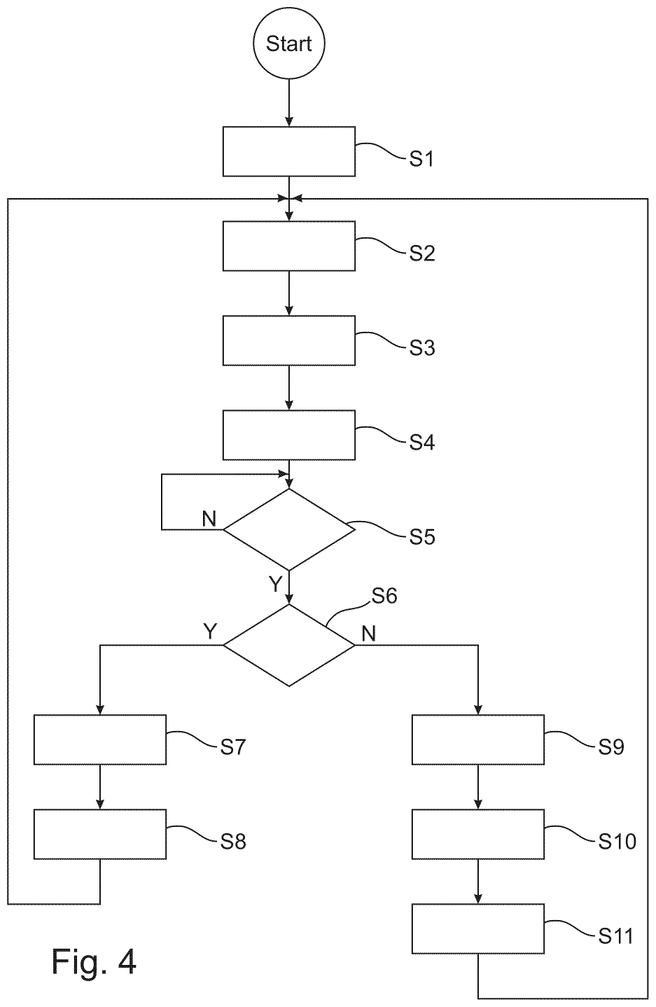

FIG. 4 shows a schematic flow diagram of an exemplary embodiment of a broadcast receiving method according to the invention.

In step S1, the table (as discussed above), is initialized with identical values (e.g. 0). In step S2, the line in the table corresponding to the currently selected service or station is considered, wherein, in step S3, the maximum value in the line is identified. The available tuner (i.e. the tuner not currently serving the selected service or station) is then set, in step S4, to this predicted station. In step S5, it is checked whether the user has selected a new station. If indeed a new station is selected by the user, it is checked in step S6 whether or not the selection matches the prediction. If indeed the selected station was predicted, the available tuner (set to the predicted station) is then used (step S7) and a positive reward is provided to increase the value of the predicted station (step S8). If the selected station was not properly predicted, tuning to the selected station is provided (using either tuner) (step S9), a reward of 0 is provided and the value of the incorrectly predicted station is reduced (step S10) and the value in the table for the actually selected station in increased (step S11). After step S8 or step S11, the process returns to step S2.

FIG. 5 shows a schematic representation for illustrating a second exemplary embodiment of the broadcast radio receiver according to the invention

The audio system 100′ shown in FIG. 5 largely corresponds to the audio system 100 shown in FIG. 3, wherein, in comparison to the predictor 101 shown in FIG. 3, the predictor 101′ of FIG. 5 and its corresponding learning framework 102′ are further configured to receive input from a locator 103 (indication of a location of the audio system, e.g. based on GPS data) and a timer 104 (indication of a time). As discussed above, also this embodiment may be modified in such way that not only the current location data is taken into consideration, but also a route, which was taken so far, leading to the current location. There is reason to assume that, if the most recent location data (i.e. at least a certain portion of the current route) matches to a previously taken route, that the user also further follows the previously taken route, which, in turn, gives rise to the assumption that the user may also repeat the previous behavior as to service selection.

In this embodiment, geopositional coordinates (e.g. GPS or Galileo) or similar location data are added as input to the predictor 101′, thus making the prediction of the user's selection behavior depend on the location and thereby increasing the hit rate. Similarly, time is provided as an additional input to the predictor 101′ in order to be able to discern selection sequences at different times of the day.

The comparatively simple approach described as to the above embodiment accounts only for predictions based solely on the currently selected station. More complex predictions based on a sequence of prior selections can be achieved by not only using the currently selected station, but also a number of previously selected stations as input to the prediction. With tabular approaches this considerably enlarges the requirement of memory resources, as the number of rows in the prediction table grows exponentially, due to the need for all combinations of previously selected stations, which would be exacerbated if additional factors (like location, time or route, etc.) are taken into consideration, resulting in a multidimensional matrix instead of a table. This can be addressed by using a Neural Network as a predictor along with an associated training algorithm, where the number of inputs to the predictor grows only linearly with the number of previous selections taken into account, and the size of the network exhibits only quadratic growth. The details of a suitable Neural Network in terms of neural architecture and number of layers are not part of this invention disclosure, since the skilled person is sufficiently familiar with such implementational issues. The focus of the present disclosure is on application of generally well-known tools, i.e. self-learning predictors, to reduce tuning times for a digital radio broadcast receiver.

The above discussed exemplary embodiments address the case where there are two (or more) tuners provided and the prediction is provided primarily for reducing a delay for switching from one service to the next service selected by the user, whereas the second tuner is set to the predicted service.

As a modification of the above, the present invention also foresees that, even in a context where only one tuner is provided, if the reception of the initially selected service is lost, the prediction as discussed above is provided for either suggesting to the user the next service (preferably reducing the user's burden in identifying the desired next service) or for already setting the predicted service in the tuner (which may result, in case of an incorrect prediction, in the need for the user for a subsequent selection of another service).

Thus, the above discussion of the embodiments applies basically—with apparent modifications also to such approach.

Even if in the drawings different aspects or features of the invention are shown in combination, the skilled person will appreciate—unless indicated otherwise—that the combinations shown and discussed are not exhaustive and variations thereof are possible. In particular, corresponding elements or feature complexes may be mutually exchanged between different embodiments.

Upon implementing the invention, single components, e.g. a processor, may fulfill a function or functions of several elements mentioned in the claims. Processes or operations like obtaining and/or processing service signals, providing audio data (and its stopping), controlling a tuner, receiving input from a user, predicting a next radio service, and updating may be realized in form of computer program code means (e.g. code elements, routines or processes) of a computer program or as dedicated hardware.

### LIST OF REFERENCE SIGNS

1 user
2 interface
3 controller
4 aerial
5 tuner
6 tuner
7 selector
8 speaker
9 predictor
10 audio system
20 audio system
100, 100′ audio system
101, 101′ predictor
102, 102′ . . . learning framework

What is claimed is:

1. A broadcast radio receiving method, comprising:
receiving an input from a user, as to a selection of a radio service;
controlling, in response to the selection of the radio service by the user, one of a first and a second tuner, so to obtain service signals from the selected radio service and to provide audio data for reproduction, wherein the first and the second tuner are each configured to obtain, independently from each other, service signals from a radio service and to provide audio data for reproduction;
predicting a next radio service based on the selected radio service, wherein the prediction is based on information as to previous sequential selections;
controlling the other one of the first and second tuner to obtain the service signals from the next radio service predicted by the predicting; and
receiving a further input from the user, as to a subsequent selection of a radio service,
wherein
if the subsequent selection corresponds to the prediction, the method further comprises stopping the provision of audio data for reproduction by the one of the first and the second tuner and controlling the other one of the first and second tuner to provide the audio data of predicted radio service for reproduction, and
if the subsequent selection does not correspond to the prediction, the method further comprises controlling either the first or second tuner, so to obtain the service signals from the radio service indicated by the subsequent selection and to provide the audio data for reproduction, and
wherein the method further comprises, in response to the subsequent selection of the radio service, updating the information as to previous sequential selections.

2. The broadcast radio receiving method according to claim 1,
wherein the predicting includes updating the information as to previous sequential selections by means of reinforcement learning.

3. The broadcast radio receiving method according to claim 1,
wherein the information as to previous sequential selections is provided in form of a table, indicating, for each of a set of services, a likelihood for a subsequent selection of another one of the set of services, or includes such table.

4. The broadcast radio receiving method according to claim 1,
wherein the information as to previous sequential selections is provided by means of a learned model, in particular based on neural network, indicating, for each of a set of services, a likelihood for a subsequent selection of another one of the set of services, or includes such learned model.

5. The broadcast radio receiving method according to claim 1,
wherein the predicting includes predicting the next radio service based on the selected radio service and a predetermined number of previously selected radio services.

6. The broadcast radio receiving method according to claim 1,
further comprising obtaining, by a locator, current location data of a broadcast radio receiver,
wherein the predicting includes predicting the next radio service based on the selected radio service and based on the current location data.

7. The broadcast radio receiving method according to claim 1,
wherein the predicting includes predicting the next radio service based on the selected radio service, based on the current location data and based on location data previous to the current location data.

8. The broadcast radio receiving method according to claim 1,
further comprising indicating a current time by a timer,
wherein the predicting includes predicting the next radio service based on the selected radio service and based on the current time.

9. The broadcast radio receiving method according to claim 1,
wherein the controlling includes releasing the other one of the first and second tuner from obtaining the service signals from the next radio service predicted by the predictor after a predetermined interval from the selection of the radio service from the user.

10. The broadcast radio receiving method according to claim 1,
wherein the controlling includes, in response to a predetermined condition, releasing the other one of the first and second tuner from obtaining the service signals from the next radio service predicted by the predictor, and
wherein the controlling further includes, after such release, again controlling the other one of the first and second tuner to obtain the service signals from the next radio service predicted by the predictor in response to a predetermined trigger condition, in particular in case of a detected stop of a vehicle in which a broadcast radio receiver is provided and/or in case of a deterioration of a reception quality of the selected radio service below a predetermined threshold.

11. A broadcast radio receiving method, comprising:
obtaining service signals from a radio service;
providing audio data for reproduction;
receiving an input from a user, as to a selection of a radio service; and
predicting a next radio service based on the selected radio service, wherein the prediction is based on information as to previous sequential selections,
wherein the method further comprises, in case of a signal loss for the selected radio service, indicating the predicted next radio service to the user or changing the obtaining of service signals to the predicted next radio service, and
wherein the method further comprises, in response to a subsequent selection of the radio service by the user via the interface, updating the information as to previous sequential selections.

12. The broadcast radio receiving method according to claim 11,
wherein the predicting includes updating the information as to previous sequential selections by means of reinforcement learning.

13. The broadcast radio receiving method according to claim 11,
wherein the information as to previous sequential selections is provided in form of a table, indicating, for each of a set of services, a likelihood for a subsequent selection of another one of the set of services, or includes such table.

14. The broadcast radio receiving method according to claim 11,
wherein the information as to previous sequential selections is provided by means of a learned model, in particular based on neural network, indicating, for each of a set of services, a likelihood for a subsequent selection of another one of the set of services, or includes such learned model.

15. The broadcast radio receiving method according to claim 11,
wherein the predicting includes predicting the next radio service based on the selected radio service and a predetermined number of previously selected radio services.

16. The broadcast radio receiving method according to claim 11,
further comprising obtaining, by a locator, current location data of a broadcast radio receiver,
wherein the predicting includes predicting the next radio service based on the selected radio service and based on the current location data.

17. The broadcast radio receiving method according to claim 11,
wherein the predicting includes predicting the next radio service based on the selected radio service, based on the current location data and based on location data previous to the current location data.

18. The broadcast radio receiving method according to claim 11,
further comprising indicating a current time by a timer,
wherein the predicting includes predicting the next radio service based on the selected radio service and based on the current time.

19. A non-volatile memory device storing a computer program that causes a computer to execute the broadcast radio receiving method according to claim 11.
